(19) United States
(12) Patent Application Publication
(10) Pub. No.: US 2007/0011221 A1
(43) Pub. Date: Jan. 11, 2007

(54) Apparatus and method for correlation operation

(75) Inventors: Syunji Mitsuishi, Hino (JP); Hideaki Yokoyama, Hino (JP)

Correspondence Address: Patrick G. Burns, Esq.;GREER, BURNS & CRAIN, LTD., Suite 2500, 300 South Wacker Drive, Chicago, IL, 60606, US

(73) Assignee: Fujitsu Limited and FCC Limited

(21) Appl. No.: 11/232,458

(22) Filed: Sep. 21, 2005

(30) Foreign Application Priority Data
Jun. 28, 2005 (JP) 2005-187563

(51) Int. Cl. G06F 17/15

(52) U.S. Cl. 708/422

(57) ABSTRACT

A data input means has a data storing unit, transfer control unit, and exclusive wiring. The data input means divides a plurality of data strings into a plurality of groups on a frequency axis. Each of the plurality of data strings includes frequency components which is Fourier-transformed. The data input means inputs the data strings to a correlation operation unit which is a computing element every divided groups which correspond with each other. The correlation operation unit performs the correlation operation every divided groups which correspond with each other in a plurality of data strings.

### CROSS-REFERENCE TO RELATED APPLICATIONS

This application claims the conventional priority based on Japanese Patent Application No.2005-187563, filed on Jun. 28, 2005, the disclosures of which are incorporated herein by reference.

### BACKGROUND OF THE INVENTION

1. Field of the Invention

This invention relates to an apparatus and method for correlation operation, and more particularly to an apparatus and method for correlation operation to perform a correlation operation in a radio interferometer by using a value which is Fourier-transformed.

2. Description of the Related Art

In a radio interferometer used for space exploration, it is known that an image of a high resolution is obtained by performing correlation operation which uses Fourier transformation to synthesize images (Fourier synthesis method) (for example, refer to Japanese Patent Application Laid-Open No. 6-266864 A).

Specifically, the radio interferometer performs FFT (Fast Fourier Transformation) operation for outputs of a plurality of radio telescopes, and then correlation operation is performed between outputs of each of antennas. This uses that a correlation function can be described by using Fourier transformation.

Conventionally, the FFT operation is applied to the outputs of each of the antennas, and the correlation operation between 2 sets of data strings is performed by using a plurality of FFT points, which is obtained by the FFT operation, as one set of data strings. For example, in a very large radio interferometer having 32 antennas (or data for right and left polarized waves for 16 antennas), it is necessary to obtain a correlation between the total of 32 sets of data strings. That is, it is necessary to perform correlation operations of 496 combinations.

For actual space exploration using a radio interferometer, it is requested to perform the above large-scale correlation operation in real time. Even when not complete real time, it is requested to perform a correlation operation in a finite time. Therefore, we studied distributed processing of a large-scale correlation operation by preparing a plurality of based (or unit) computing elements (e.g. DSPs: Digital Signal Processors).

FIG. 6 shows an example in which one based computing element is assigned to one combination of correlation operations, in the above mentioned example for obtaining corrective operations of the 32 sets of data strings. However, according to this example, though the concept can be easily understood, 496 based computing elements must be used and wiring becomes complex. Therefore, this is not practically usable.

Therefore, taking the throughput of one based computing element into consideration, we considered to use a plurality of based computing elements, each of which processes a plurality of combinations of correlation operations. In this case, we considered various configurations, and one of them is shown in FIGS. 7A and 7B.

FIGS. 7A and 7B respectively show examples of constituting a correlation operation apparatus for processing 32 sets of data strings by using a plurality of based computing elements each of which can process 16 sets of data strings. In FIGS. 7A and 7B, 32 sets of data strings are divided into 4 groups every 8 sets, and the correlation operation is processed by 6 based computing elements #1 to #6. The necessary number of based computing elements is depend on a number of sets of input data, a number of inputs which can be inputted into one based computing element, and signal throughput of one based computing element. In FIGS. 7A and 7B, a capacity for performing the correlation operation of 2 sets of data strings (a number of data values and size of one data value are assumed to be unchanged) is defined as “computing power=1”, to show a computing power of each of a based computing element, and one set of data strings is shown as “input #1”. Moreover, in FIGS. 7A and 7B, by attaching “8” to a wiring, it shows that the present one solid line shows a wiring for inputting 8 sets of data values (the same is also applied to FIG. 4B).

In FIG. 7A, 16 sets of inputs #1 to #8 and #9 to #16 are inputted to a based computing element #1. The based computing element #1 performs correlation operations between all of 16 sets of inputs #1 to #8 and #9 to #16. In this case, computing power requested for the based computing element #1 is “120”. 16 sets of inputs #1 to #8 and #17 to #24 are inputted to the based computing element #2. The based computing element #2 performs all correlation operations between 16 sets of inputs #1 to #8 and #17 to #24.

However, correlation operations between inputs #1 to #8 are all completed in the based computing element #1. Therefore, though inputs #1 to #8 are also input to the based computing element #2 for correlation operations with inputs #17 to #24, a contradiction occurs that the correlation operations between inputs #1 to #8 are unnecessary in the based computing element #2. For this reason, waste occurs that connection is necessary though a part of correlation operations are unnecessary. Moreover, since the connection is complex as shown in FIG. 7A, it is induced to increase cost for connection, to increase power consumption, and to mistake wiring in assembling or maintaining a correlation operation apparatus and the like. The same problem occurs in the based computing elements #3, #4, #5, and #6.

Moreover, since the based computing element #1 performs all correlation operations between 16 sets of inputs #1 to #8 and #9 to #16, the computing power of “120” is requested. The based computing element #2 performs the number of correlation operations obtained by subtracting correlation operations between inputs #1 to #8 from all correlation operations between 16 sets of inputs #1 to #8 and #17 to #24. Therefore, “92” is sufficient for the computing power of the based computing element #2. Moreover, “64” is sufficient for the computing power of the based computing element #4. Thus, when the correlation operation is assigned from the based computing element #1 to subsequent ones in order, three types of computing powers requested for a based computing element such as “120”, “92”, and “64” are generated. Therefore, it is necessary to prepare three types of based computing elements having different computing powers. Moreover, even if contriving assignment of correlation operations to based computing elements, two types of based computing elements having computing powers of “120” and “64” are necessary, as shown in FIG. 7B.

It is advantageous for constituting a correlation operation apparatus to prepare a plurality of based computing elements having different computing powers. Therefore, it seems to be able to restrain a cost of a correlation operation apparatus. However, because it is necessary to develop a plurality of types of based computing elements, it causes the development cost of a correlation operation apparatus to rise as a result.

On the contrary, we considered to compose a correlation operation apparatus by only one type of a based computing element having the maximum computing power (such as computing power of “120”). In this case, since a number of types of based computing elements is “1”, it is possible to restrain the development cost of a correlation operation apparatus. However, unification by the maximum computing power causes to mount redundant power, and as a result, causes to rise the cost of a correlation operation apparatus.

Moreover, in FIGS. 7A and 7B, when the computing time for “1” computing power is the same, even if all based computing elements are operated in parallel at the same timing, the whole processing time is depend on the processing time in a based computing element (#1, for example) for which the maximum computing power is requested, and waste occurs in the processing time.

### SUMMARY OF THE INVENTION

It is an object of the present invention to provide a correlation operation apparatus having an understandable configuration and effectively using computing power by regular input to one type of a based computing element.

It is another object of the present invention to provide a correlation operation method having an understandable configuration and effectively using computing power by regular input to one type of a based computing element.

A correlation operation apparatus of the present invention includes data input means dividing each of a plurality of data strings into a plurality of groups on a frequency axis, each of the plurality of data strings including frequency components which is Fourier-transformed, and inputting the data strings to a computing element every predetermined divided groups which correspond with each other in the plurality of data strings, and a computing element performing a correlation operation every the predetermined divided groups which correspond with each other in the plurality of data strings.

Moreover, preferably, in a correlation operation apparatus of the present invention, the computing element comprises a plurality of based computing elements, and each of the plurality of based computing elements performs in parallel correlation operation for the predetermined divided groups which are different from each other.

Furthermore, preferably, in a correlation operation apparatus of the present invention, the divided groups are previously related with the plurality of based computing elements according to positions on a frequency axis of the divided groups in the data string.

Moreover, preferably, a correlation operation apparatus of the present invention further includes a switching unit switching inputs of data from the data input means to the computing element. And, the computing element comprises one based computing element, and the computing element performs in time division every the predetermined divided groups a correlation operation every the predetermined divided groups by using the one based computing element.

A correlation operation method of the present invention includes dividing each of a plurality of data strings into a plurality of groups on a frequency axis, each of the plurality of data strings including frequency components which is Fourier-transformed, inputting the data strings to a computing element every predetermined divided groups which correspond with each other in the plurality of data strings, and performing a correlation operation every the predetermined divided groups which correspond with each other in the plurality of data strings.

In a correlation operation apparatus and a correlation operation method of the present invention, each of a plurality of data strings including frequency components which is Fourier-transformed are divided into a plurality of groups on a frequency axis, and a computing element performs the correlation operation every divided groups which correspond with each other in a plurality of data strings. That is, the present invention does not directly use a plurality of data strings composed of frequency components for the unit of operation, but the present invention divides the plurality of data strings so as to cross the data strings every frequency component to generate a unit of operation.

Accordingly, in the present invention, it is possible to use one type of (computing power of) a based computing element which composes a correlation operation apparatus. Therefore, according to the present invention, by eliminating unnecessary input to a based computing element and the waste of connection to the based computing element, it is possible to eliminate the waste of the computing power of a based computing element and maximally use the based computing element. As a result, according to the present invention, it is possible to prevent redundant computing power from being mounted on a correlation operation apparatus. Moreover, according to the present invention, when distributed processing in a large-scale correlation operation, it is possible to restrain a number of based computing elements. Moreover, according to the present invention, it is possible to make connection for correlation operation apparatus understandable, to restrain power consumption, and to decrease a number of erroneous wirings in fabrication and maintenance of a correlation operation apparatus.

Furthermore, in a correlation operation apparatus of the present invention, a plurality of based computing elements performs in parallel correlation operations every divided groups, and the divided groups are predetermined and different from each other. Therefore, according to the present invention, when operating all based computing elements in parallel at the same timing, it is possible to eliminate the waste of processing time and minimize the whole processing time.

Moreover, in a correlation operation apparatus of the present invention, the divided groups are previously related with the plurality of based computing elements. Therefore, according to the present invention, it is possible to further eliminate the waste of connection to a based computing element and the waste of the computing power of the based computing element. As a result, it is possible to make connection for correlation operation apparatus further understandable, to restrain power consumption, and to decrease the number of erroneous wirings in fabrication and maintenance of the correlation operation apparatus.

Furthermore, in a correlation operation apparatus of the present invention, one based computing element performs in time division correlation operations every divided groups. Therefore, according to the present invention, when a request for a real time operation is not severe, it is possible to minimize a number of computing elements (e.g. only one), to make connection in the correlation operation apparatus very understandable, and to decrease a number of erroneous wirings in fabrication and maintenance of correlation operation apparatus.

### BRIEF DESCRIPTION OF THE DRAWINGS

FIGS. 1A and 1B show an embodiment of a configuration and another embodiment of configuration of a correlation operation apparatus of the present invention.

FIGS. 2A and 2B are illustrations of the correlation operation apparatus in FIG. 1A.

FIGS. 3A and 3B are illustrations of the correlation operation apparatus in FIG. 1A.

FIGS. 4A and 4B are illustrations of the correlation operation apparatus in FIG. 1A.

FIGS. 5A and 5B are illustrations of the correlation operation apparatus in FIG. 1B.

FIG. 6 is an illustration showing the background of the present invention.

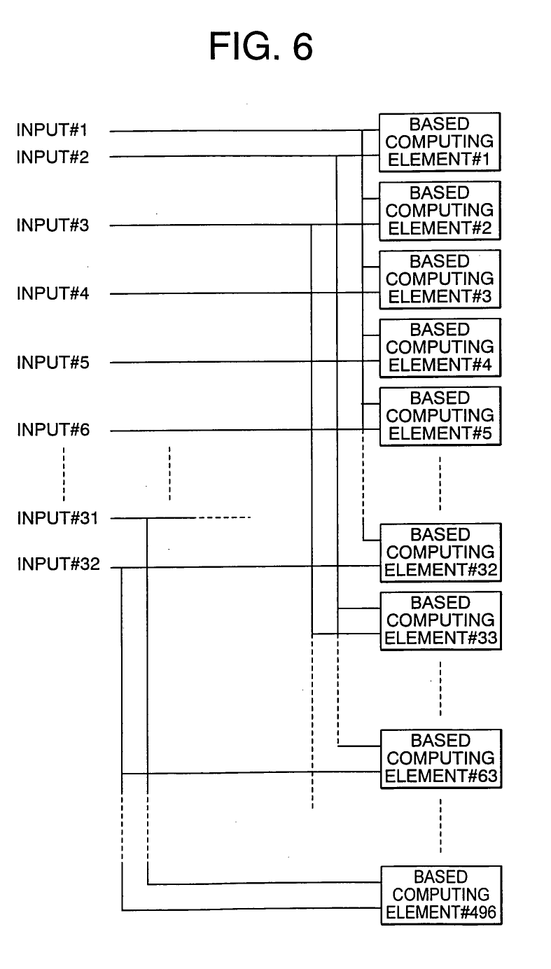

FIGS. 7A and 7B are illustrations showing the background of the present invention.

### DETAILED DESCRIPTION OF THE PREFERRED EMBODIMENTS

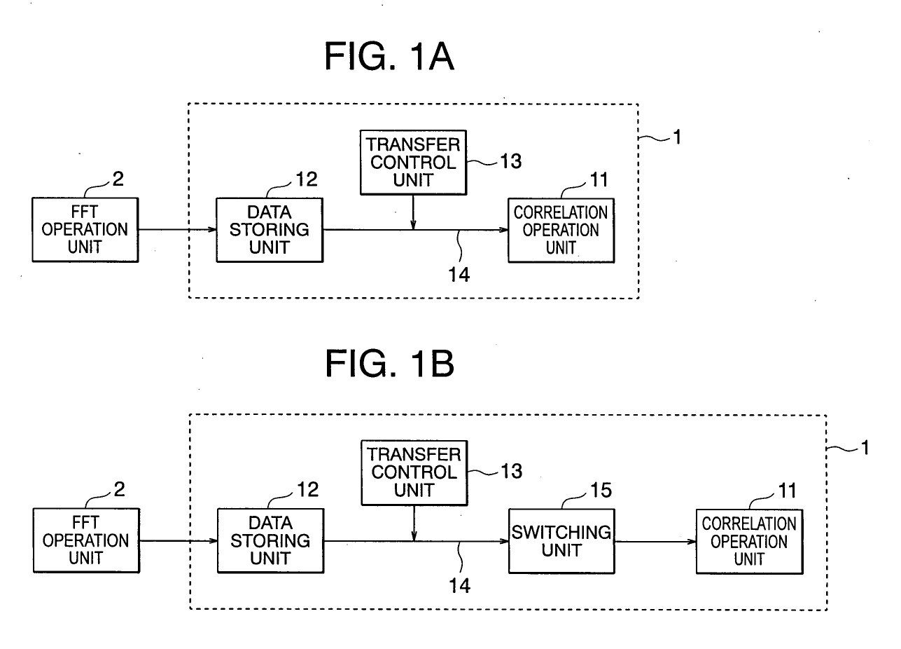

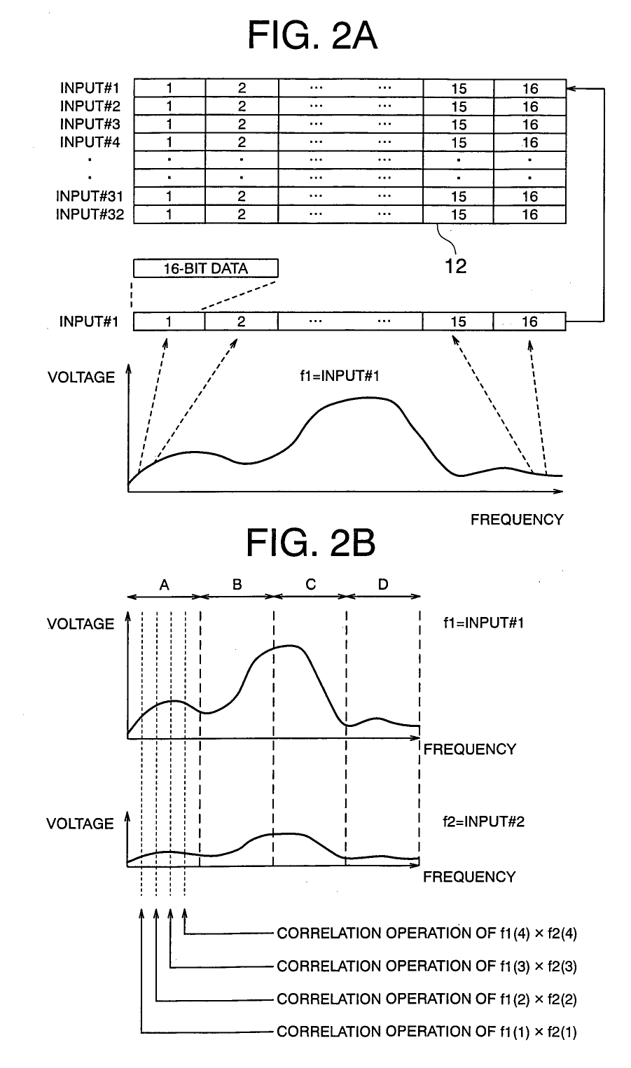

FIG. 1A is a block diagram of a correlation operation apparatus of the present invention, which shows an embodiment of a configuration of the correlation operation apparatus of the present invention. FIGS. 2A to 4B are illustrations of the correlation operation apparatus in FIG. 1A.

A correlation operation apparatus 1 comprises a correlation operation unit 11, a data storing unit 12, a transfer control unit 13, and an exclusive wiring 14 which connects between them. The data input means comprises the data storing unit 12, the transfer control unit 13, and the exclusive wiring 14. The correlation operation apparatus 1 is connected with an FFT operation unit 2 which performs an FFT (Fast Fourier transformation) operation, and performs a correlation operation by the correlation operation unit 11 by using a result of the FFT operation.

The correlation operation unit 11 is a computing element which performs a correlation operation, and comprises a DSP to execute the correlation operation for the data stored in the data storing unit 12, for example. The data storing unit 12 comprises a DRAM (Dynamic Random Access Memory) to store the data for a correlation operation, for example. The data storing unit 12 may comprise a SRAM (Static Random Access Memory), for example. The correlation operation unit 11 and the data storing unit 12 are connected each other by the fixed exclusive wiring 14. As shown by an arrow in FIG. 1A, the transfer control unit 13 controls data transfer of the exclusive wiring 14. The transfer control unit 13 comprises a well-known DMA (Direct Memory Access) controller, for example.

The data stored in the data storing unit 12 is obtained as described below. For example, 32 antennas of a radio interferometer successively output detection signals (GHz band) which are observation results. Thereby, a plurality (32 sets) of data strings are obtained. 32 sets of the data strings of are shown as “input #1 to input #32”, as shown in FIG. 2A.

Each of the data strings “input #1 to input #32” are amplified and AD (Analog-to-Digital)-converted, and then Fourier-transformed (FFT) by the FFT operation unit 2. The results of the FFT are regularly stored in the data storing unit 12. That is, when assigning frequency to the axis of abscissa and voltage to the axis of ordinate, the result of the FFT operation is a spectrum at the frequency, as schematically shown in FIG. 2A. Therefore, the data storing unit 12 stores a plurality of data strings “input #1 to input #32”, each of the plurality of data strings including frequency components which is Fourier-transformed.

For example, as shown in FIG. 2A, one data value is a spectrum (frequency component) of the specified frequency (f1(1) to be described later, for example), and is 16-bit digital data. One set of data strings (e.g. input #1) is actually composed of 1M (mega) data values. However, in FIG. 2A, it is assumed that the one set of data strings is composed of 16 data values, for simplification of the illustration (the same is also applied hereafter).

In the data storing unit 12, a plurality of data values (16 data values) in one set of data strings is the data stored in order of being outputted from the FFT operation unit 2. As described above, 32 sets of data strings “input #1 to input #32” are outputted in parallel from the FFT operation unit 2 starting with the head data. The data storing unit 12 has 32 sets of memory areas respectively corresponding to each of the plurality of data strings. The 32 sets of memory areas store output data starting with the head area according to the order of output. Thereby, as shown in FIG. 2A, the position of one data value in the data string and the position of the one data value in the data storing unit 12 are decided according to a position on a frequency axis of the one data value. These positions always correspond to each other, and this relation is maintained.

It is noticed in the present invention that correlation operation for the data composed of frequency components is product operation between the same frequency components every set of input combinations, as shown in FIG.2B. That is, when showing inputs #1 and #2 as f1 and f2 and the value of f1 at a first frequency as f1(1), each of correlation operations between the input #1 and input #2 are operations such as f1(1)×f2(1), f1(2)×f2(2), . . . , and f1(16)×f2(16).

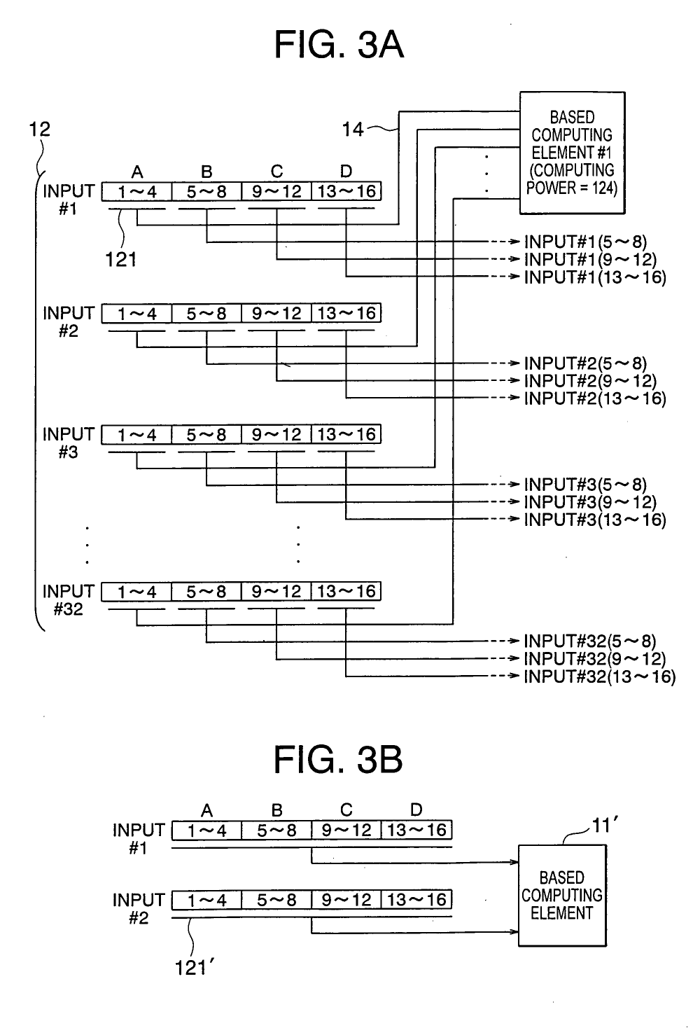

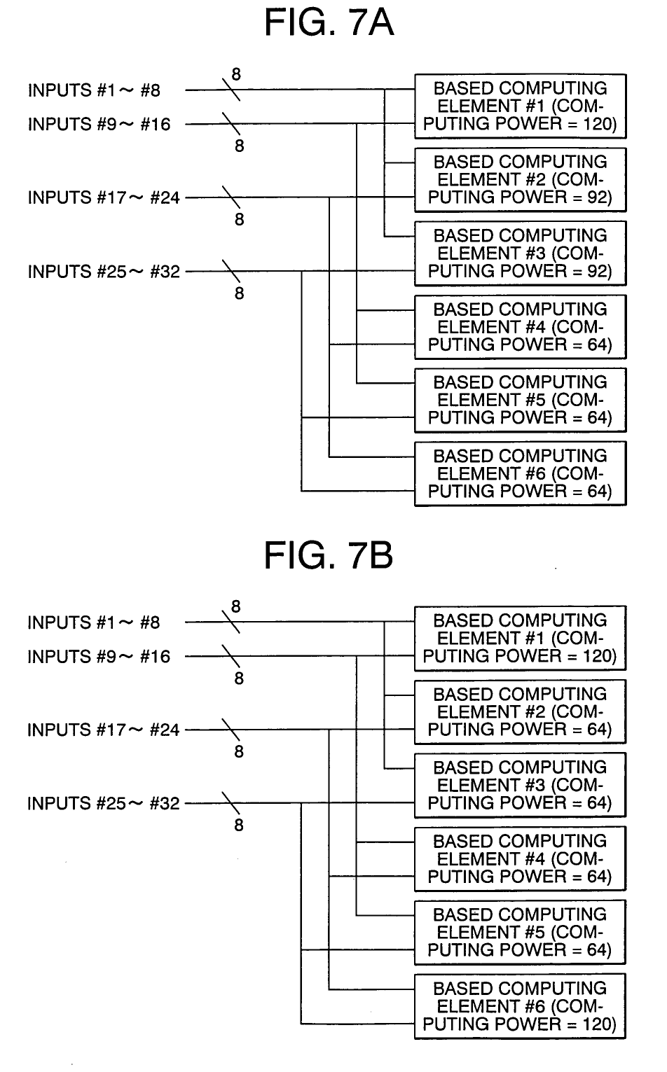

Conventionally, as shown in FIGS. 7A and 7B, all correlation operations between data strings “input #1 and input #2” are processed in the same based computing element #1. Therefore, all of the data values in the data strings “input #1 and input #2” are inputted to the same based computing element (refer to FIG. 3B). However, principally, there is no reason, for example, that the operation of f1(1)×f2(1) and the operation of f1(16)×f2(16) must be executed in the same based computing element #1. There is no problem when it is possible to keep the relation between the position on the frequency axis of the data, the position of the data in the data string, and the position of the data in the data storing unit 12.

Therefore, in the present invention, as shown in FIG. 2B, each of the plurality of data strings is divided into a plurality of groups (4 groups) A, B, C, and D, and input from the data storing unit 12 to the correlation operation unit 11 is performed every divided groups. In this example, a data string is divided into 4 equal portions. Accordingly, for example, each of groups is composed of 4 data values, and the group A of input #1 is composed of values f1(1), f1(2), f1(3), and f1(4) at first, second, third, and fourth frequencies, respectively. The groups A to D are a plurality of groups which are continuous on a frequency axis in one data string, and are used as a unit for dividing a frequency. Therefore, a correlation operation of the present invention is not performed for the data string such as “input #1” as conventional.

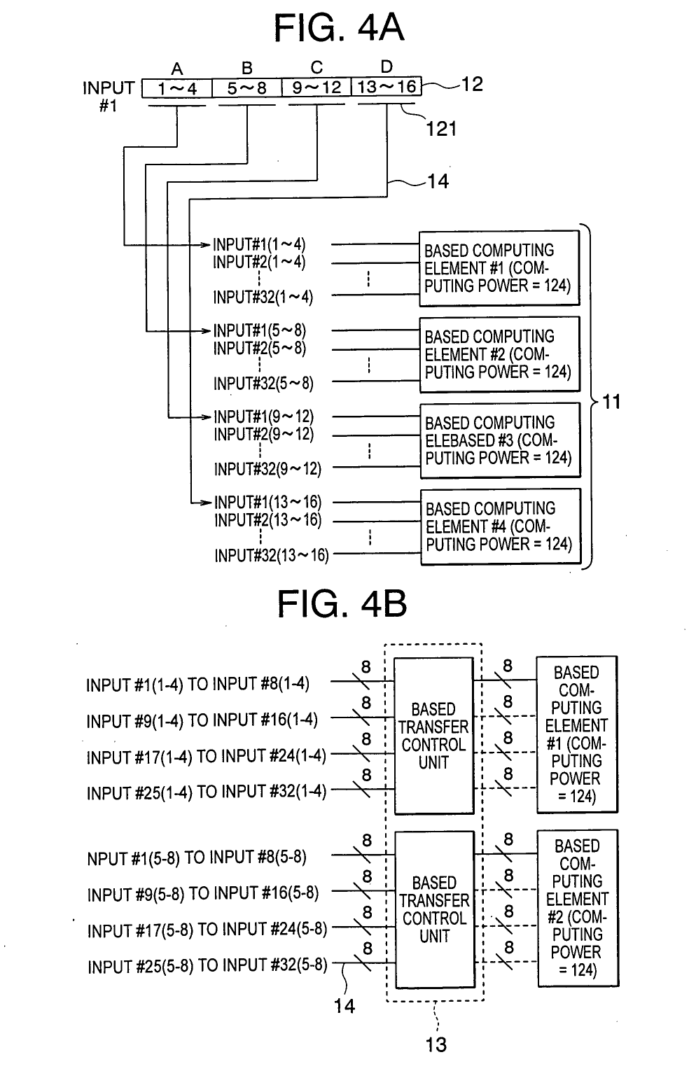

FIGS. 3A and 4A show the configuration of the data input means in the embodiment of FIG. 1A, particularly a configuration of the data storing unit 12 and exclusive wiring 14.

Even if a number of data values in one set of the data strings is changed from 1M to 16 to simplify the description, a number of exclusive wirings 14 is greatly increased. So, FIGS. 3A and 4A are united to show a configuration of the data storing unit 12 and exclusive wiring 14. FIG. 3A is an illustration emphasizing connection of the data storing unit 12. FIG. 4A is an illustration emphasizing connection of a based computing element.

FIG. 3A shows that a plurality of group A which correspond with each other (same group) in the plurality of data strings “input #1 to input #32” is inputted to the same based computing element #1. The same is also applied to other groups B, C, and D. FIG. 4A shows that one set of data strings “input #1” is inputted to different based computing elements #1, #2, #3, and #4 every groups A, B, C, and D. The same is also applied to other data strings. That is, in FIGS. 3A and 4A, each of 32 sets of data strings each of which is composed of 16 frequency data values are divided into 4 groups on a frequency axis, input to different based computing elements every groups to perform correlation operation. According to the present invention, all data values of one set of data string such as “input #1”, for example, are not input to the same based computing element #1. Still in FIGS. 3A and 3B and FIGS. 4A, symbols of groups A to D are provided for only “input #1”.

Specifically, as shown in FIGS. 3A and 4A, data input means divides each of the plurality of data strings “input #1 to input #32” into a plurality of groups A to D on a frequency axis. Each of the plurality of data strings comprises frequency components which is Fourier-transformed. And, the data input means inputs the groups, which corresponding with each other, to the same based computing elements #1 to #4 in the correlation operation unit 11 every divided groups A to D which correspond with each other in a plurality of data strings “input #1 to input #32”. Therefore, the correlation operation unit 11 performs the correlation operation every divided groups A to D which correspond with each other in a plurality of data strings “input #1 to input #32”.

In this embodiment, the correlation operation unit 11 serving as a computing element comprises 4 (a plurality of) based computing elements #1 to #4, as shown in FIG. 4A. The 4 based computing elements #1 to #4 respectively perform the correlation operation every divided groups in parallel. That is, the 4 based computing elements #1, #2, #3, and #4 perform in parallel correlation operations for the predetermined divided groups A, B, C, and D, which correspond with each other, respectively. It is possible to decrease the correlation operation time by the parallel operation using a plurality of based computing elements.

The divided groups A, B, C, and D are previously related with the plurality of based computing elements #1, #2, #3, and #4 according to the position on a frequency axis (that is, frequency) of the group in the data string. That is, the first group A corresponds to the first based computing element #1. The same is also applied to other groups and based computing elements. Thereby, it is possible to fix the exclusive wiring 14 and make the wiring 14 understandable.

Each of 4 based computing elements #1 to #4 comprises a semiconductor device (DSP) which has the same configuration and the same correlation operation power. As shown in FIG. 4A, each of the 4 based computing elements #1 to #4 has a computing power of “124”. Thereby, by preparing one type of a based computing element, it is possible to compose a correlation operation apparatus. In FIGS. 3A and 4A, to exhibit the computing power of each of based computing elements, the power for performing correlation operations of 2 sets of data strings which is composed of 16 discrete numbers (one data value is composed of 16 bits) is defined as “computing power=1”.

A number of the based computing elements n (=4) is made equal to a number of the divided groups n (=4). That is, in each of the data strings, divided groups A, B, C, and D are inputted to different based computing elements #1, #2, #3, and #4, respectively. Thereby, the configuration of a correlation operation apparatus is further simplified.

Each of the plurality of groups A to D includes the same number of data values. For example, in this embodiment, the group A is composed of 4 data values (1 to 4). In other words, each of the plurality of groups A to D has the same frequency band width with each other, as shown in FIG. 2B. That is, each of the plurality of groups has a frequency band width (a number of data values) obtained by dividing a band width (that is, a data string) to be observed into n equal portions.

Moreover, each of a plurality of groups A to D may not have the same number of data values. For example, when a number of data values in one set of data strings is “15”, it is allowed that each of the groups A, B, and C is composed of 4 data values and the group D is composed of 3 data values.

As shown in FIGS. 3A and 4A, the data storing unit 12 of the data input means is provided with a plurality of data read means 121 every divided groups A, B, C, and D in (the memory area of) the one set of data string. The data read means 121 is shown by attaching a symbol to only “input #1”. That is, each of the plurality of data strings are provided with a plurality of data read means 121. Thereby, each of the plurality of data strings are divided into the plurality of groups on a frequency axis. The data storing means 12 is means for dividing one data string into the plurality of groups in the data input means.

As shown in FIG. 3B, since the data storing means 12 conventionally inputs all of the data values of one data string to the same based computing element 11′, data read means 121′ is provided only every data string.

The data storing unit 12 in the data input means and based computing elements corresponding with each other is fixedly connected by the exclusive wiring 14 every data read means 121. As described above, the divided groups A, B, C, and D are inputted to different based computing elements #1, #2, #3, and #4 in each of the plurality of data strings, as shown in FIG. 4A. That is, the exclusive wiring 14 (and the transfer control unit 13) are means for inputting a data string to the correlation operation unit 11 (corresponding based computing element) in the data input means. Thereby, the data in the plurality of data strings is inputted to different based computing elements every divided groups which correspond with each other. As a result, each of the based computing elements perform correlation operations every divided groups in the plurality of data strings.

As described above, in the present invention, each of the data which composes a data string is related with different based computing elements and input, every not data string but every divided groups. Moreover, as shown in FIG. 4A, all of the based computing elements #1 to #4 perform correlation operations of the same groups in 32 sets of data strings. Thereby, the data storing unit 12 is regularly and fixedly connected with the based computing elements #1 to #4. Therefore, it is possible to make connection regular and eliminate the waste of wiring, so that it is possible to optimize fabrication (assembling) of a correlation operation apparatus to a necessary power.

In FIGS. 3A and 4A, all of the based computing elements #1 to #4 perform correlation operations in parallel at the same timing. For example, at the timing on which the first data of the data string “input #1” is inputted to the based computing element #1, the first data of the remaining data strings “inputs #2 to #32” is inputted to the based computing element #1, and moreover, the fifth, ninth, and thirteenth data values of the data strings “inputs #1 to #32” are inputted to the based computing elements #2, #3, and #4, respectively. Thereby, it is possible to perform correlation operations between these data values in parallel at the same timing. Hereafter, correlation operations are similarly performed in parallel for the next data in 32 sets of data strings “inputs #1 to #32”. Thereby, all of the based computing elements #1 to #4 can complete predetermined correlation operations in the same processing time, and can minimize (optimize) the operation processing time.

Actually, there is a restriction on a number of input terminals (pins) of the based computing elements #1 to #4. Therefore, for example, the based computing element #1 which performs the correlation operation of the data of the group A as described below.

That is, firstly the data values for the data strings “input #1 to input #8” are inputted. FIG. 4B shows this state by representing input of other data string to the based computing element #1 with a dotted line. In this input, first data (f1(1) etc.) of each of the data strings “input #1 to input #8” is inputted in parallel, and then a executable correlation operation is started in response to the input. These data values are held until the correlation operation for the first data is completed. Then, similarly, first data of each of the data strings “input #9 to input #16”, first data of each of the data strings “input #17 to input #24”, and first data of each of data strings “input #25 to input #32” are inputted in order, and correlation operations are performed. Thereby, the correlation operation for the first data of each of all of the data strings “input #1 to input “32” is completed. Hereafter similarly, the second, third, and fourth data values of the data strings “input #1 to input 8” are inputted in order, and the correlation operation is performed for each of the data values. The same is applied to other based computing elements #2 to #4.

The order of data transfer above described is previously decided, and controlled by the transfer control unit 13, as shown in FIG. 4B. For example, the transfer control unit 13 comprises a based (or unit) transfer control unit which is provided correspondingly to each of based computing elements. FIG. 4B only shows based computing elements #1 and #2, but omits others. Therefore, the fixed exclusive wiring 14 is actually provided between the data storing unit 12 and the transfer control unit 13. However, as shown in FIG. 4B, relation between the groups in each of the plurality of data strings and the based computing element is fixedly and regularly decided according to the position of the data or the position of the group in the data string.

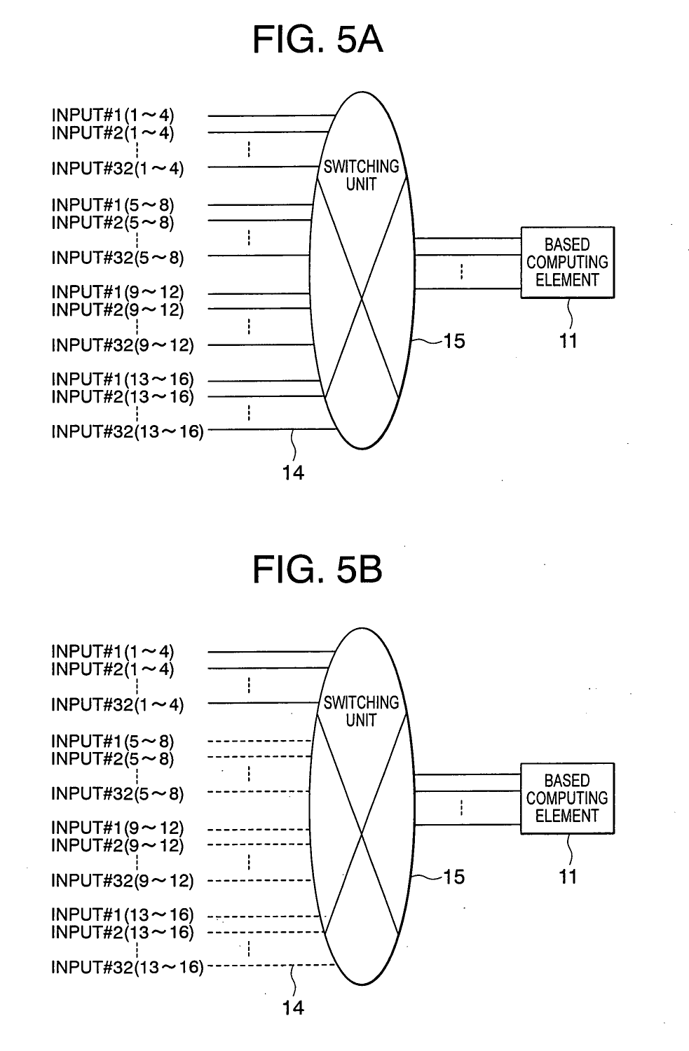

FIG. 1B is a block diagram of a correlation operation apparatus, showing another embodiment of the configuration of a correlation operation apparatus of the present invention. FIGS. 5A and 5B are illustrations of the correlation operation apparatus in FIG. 1B. In FIGS. 5A and 5B, since the correlation operation apparatus of this embodiment has the same configuration as the embodiment in FIG. 1A up to the transfer control unit 13, only a switching unit 15 is shown.

In this embodiment, the correlation operation unit 11 serving as a computing element comprises one based computing element. Due to this structure, as shown in FIG. 5A, the correlation operation apparatus 1 has a switching unit 15. As shown in FIG. 5B, the switching unit 15 successively switches input of data from the data storing unit 12 serving as data input means to the correlation operation unit 11. Thereby, one based computing element performs the correlation operation every divided groups, in time division every divided groups.

That is, the divided groups A to D are inputted to one based computing element (that is, correlation operation unit 11) in a predetermined sequence according to the position on a frequency axis (that is, frequency) of the group in the data string by the switching unit 15. In this embodiment, the input sequence is the sequence of positions of the group on the frequency axis in the data strings. Therefore, the group A of the data strings “input #1 to input #32” is inputted firstly. FIG. 5B shows this state by representing inputs of other groups B to D with dotted lines.

In this embodiment, 32 sets of data strings, which is respectively composed of 16 frequency data values, are divided into 4 portions on a frequency axis as same as FIG. 1A, but the divided portions are inputted to one based computing element in time division every divided portions to perform a correlation operation. Thereby, as compared with FIG. 1A, it is possible to make connection further regular though the computing speed is rather slow, and to eliminate waste. Therefore, it is possible to prevent the cost for connection and power consumption from increasing, and to reduce induction of errors in assembling and maintenance of a correlation operation apparatus.

As described above, according to the present invention, in a correlation operation apparatus and a correlation operation method, it is possible to restrain a number of computing elements, to eliminate waste of the computing power of a computing element, and to make connection in correlation operation apparatus understandable. Thereby, it is possible to realize at a low cost a correlation operation apparatus which has an understandable configuration and can perform a large-scale correlation operation by the distributed processing. Moreover, since wastes of input and connection can be eliminated, it is possible to reduce the connection cost included in the product cost, to reduce power consumption, and to decrease a number of operation errors in fabrication and maintenance.

Moreover, according to the present invention, in a correlation operation apparatus and a correlation operation method, since a correlation operation apparatus can be composed by one type of a computing element, it is possible to restrain the development cost of a based computing element and a correlation operation apparatus in its turn. Furthermore, since an optimized correlation operation apparatus excluding redundancy can be constituted, it is possible to realize a correlation operation apparatus having no waste in product cost.

Furthermore, according to the present invention, in a correlation operation apparatus and a correlation operation method, when performing parallel processing, it is possible to minimize (that is, optimize) the whole processing time, and when performing time division processing (or when request for real time is not severe), it is possible to minimize the number of computing elements and to restrain the cost of a correlation operation apparatus.

What is claimed is:

1. A correlation operation apparatus comprising:
data input means dividing each of a plurality of data strings into a plurality of groups on a frequency axis, each of the plurality of data strings including frequency components which is Fourier-transformed, and inputting the data strings to a computing element every predetermined divided groups which correspond with each other in the plurality of data strings; and
a computing element performing a correlation operation every the predetermined divided groups which correspond with each other in the plurality of data strings.

2. The correlation operation apparatus according to claim 1, wherein the plurality of groups have the same frequency band width with each other.

3. The correlation operation apparatus according to claim 1,
wherein the computing element comprises a plurality of based computing elements, and
wherein each of the plurality of based computing elements performs in parallel correlation operation for the predetermined divided groups which are different from each other.

4. The correlation operation apparatus according to claim 3, wherein the divided groups are previously related with the plurality of based computing elements according to positions on a frequency axis of the divided groups in the data string.

5. The correlation operation apparatus according to claim 3, wherein each of the plurality of based computing elements comprises a semiconductor device having the same configuration and the same correlation operation power.

6. The correlation operation apparatus according to claim 3, wherein a number of the plurality of based computing elements is equal to a number of the predetermined divided groups.

7. The correlation operation apparatus according to claim 3, wherein the data input means has a memory provided with a plurality of data read means, each of the plurality of data read means corresponding to each of the plurality of groups.

8. The correlation operation apparatus according to claim 7, wherein the memory of the data input means and the based computing elements are connected by exclusive wirings.

9. The correlation operation apparatus according to claim 1, further comprising:
a switching unit switching inputs of data from the data input means to the computing element,
wherein the computing element comprises one based computing element, and
wherein the computing element performs in time division every the predetermined divided groups a correlation operation every the predetermined divided groups by using the one based computing element.

10. The correlation operation apparatus according to claim 9, wherein the predetermined divided groups are inputted to the one based computing element in a predetermined sequence by the switching unit according to the position on a frequency axis of the predetermined divided group in the data string.

11. A correlation operation method comprising:
dividing each of a plurality of data strings into a plurality of groups on a frequency axis, each of the plurality of data strings including frequency components which is Fourier-transformed;
inputting the data strings to a computing element every predetermined divided groups which correspond with each other in the plurality of data strings; and
performing a correlation operation every the predetermined divided groups which correspond with each other in the plurality of data strings.

12. The correlation operation method according to claim 11,
wherein the computing element comprises a plurality of based computing elements, and
wherein the correlation operation every the predetermined divided groups is performed in parallel by the plurality of based computing elements.

13. The correlation operation method according to claim 11,
wherein the computing element comprises one based computing element, and
wherein the correlation operation every the predetermined divided groups is performed in time division by the one based computing element.
